(19) United States
(12) Patent Application Publication
(10) Pub. No.: US 2024/0328470 A1
(43) Pub. Date: Oct. 3, 2024

(54) Brake Dust Particle Filter, Disc Brake Assembly, and Filter Insert Part

(71) Applicant: MANN+HUMMEL GmbH, Ludwigsburg (DE)

(72) Inventors: Tobias WOERZ, Leutenbach (DE); Andreas BECK, Kirchheim (DE); Benedikt WELLER, Steinheim (DE)

(21) Appl. No.: 18/184,740

(22) Filed: Mar. 16, 2023

Related U.S. Application Data
(63) Continuation of application No. PCT/EP2021/074486, filed on Sep. 6, 2021.

(30) Foreign Application Priority Data
Sep. 28, 2020 (DE) 102020125273.0

(51) Int. Cl. F16D 65/00; B01D 46/00; B01D 46/12; B01D 46/16

(52) U.S. Cl. CPC F16D 65/0031; B01D 46/0005; B01D 46/12; B01D 46/16; F16D 55/22

(57) ABSTRACT

A brake dust particle filter for a disc brake assembly has a ring segment-shaped housing configured to at least partially accommodate a brake disc. The housing has first and second housing side walls which are axially spaced apart from each other. The housing has a housing circumferential wall section extending radially outwardly in a circumferential direction and arranged between the first and second housing side walls. One or more guide ribs project inwardly with an axial component into the housing interior away from the first housing side wall. The guide ribs are arranged adjacent to a respective opening in the housing side wall. The guide ribs are covered at least partially by a filter medium. The respective opening connects the housing interior in fluid communication to an exterior space not enclosed by the housing so that an air flow is enabled between the housing interior and the exterior space.

### CROSS-REFERENCE TO RELATED APPLICATIONS

This application is a continuation application of International Application No. PCT/EP2021/074486 filed on Sep. 6, 2021, which claims the benefit of German Application No. 10 2020 125 273.0 filed on Sep. 28, 2020, the entire disclosures of which are incorporated herein by reference for all purposes.

### BACKGROUND

The invention concerns a brake dust particle filter for a disc brake assembly with a brake disc and a brake caliper. The brake dust particle filter is configured to catch particles produced during braking. The invention concerns furthermore a disc brake assembly with such a brake dust particle filter and a filter insert part of a brake dust particle filter.

It is known to catch and to dispose of particles produced by brake abrasion by means of a brake dust particle filter. Such particles are produced by friction between brake pad and brake disc of a disc brake. Such a brake dust particle filter is disclosed, for example, in DE 10 2019 105 862 A. For increasing the surface available for filtration, it is provided therein to provide a filter medium in the form of tongues or folds at the housing circumferential wall in the interior of the housing.

A disadvantage thereof is however that a circumferential flow (boundary layer) caused by the rotation of the brake disc in operation generates a relative excess pressure in the housing of the brake dust particle filter which leads to a portion of the particles to be separated not remaining within the brake dust particle filter but escaping again by leakage at the interfaces in relation to the brake caliper and/or the brake disc.

### SUMMARY

In view of this, it is object of the present invention to provide a brake dust particle filter which is configured more efficiently for separation of particles produced during braking and, in particular in operation, comprises a reduced inner pressure.

Object of the present invention is furthermore to provide a disc brake assembly with such a brake dust particle filter.

Object of the present invention is furthermore to provide a filter insert part of a brake dust particle filter which enables a simple and uncomplicated servicing.

The brake dust particle filter according to the invention is suitable for arbitrary applications of disc brakes, for mobile as well as stationary applications. In the mobile applications, for example, it can be used in passenger cars, trucks, buses, rail vehicles. Stationarily, for example, in shaft brakes as they are used in wind power facilities.

This object is solved by a brake dust particle filter for a disc brake assembly with a brake disc and a brake caliper, wherein the brake dust particle filter is configured to catch particles produced during braking, and wherein the brake dust particle filter comprises the following:
a ring segment-shaped housing for at least partial accommodation of the brake disc in a housing interior, wherein the housing comprises two housing side walls axially spaced apart from each other and a housing circumferential wall section extending radially outwardly in circumferential direction, and wherein the housing circumferential wall section is arranged or embodied between the housing side walls;
at least one guide rib projecting in the housing interior inwardly from at least one housing side wall at least in sections with at least one axial component;
wherein the guide rib is arranged adjacent to at least one opening present in the housing side wall and the guide rib is covered at least partially by a filter medium, wherein the opening connects the housing interior in fluid communication to an exterior space not enclosed by the housing so that through the opening an air flow is enabled between the housing interior and the exterior space, or vice versa.

The object is further solved by a disc brake assembly, with a brake disc, a brake caliper, and a brake dust particle filter, wherein the brake dust particle filter is a brake dust particle filter as disclosed herein.

The object is further solved by a filter insert part of a brake dust particle filter as disclosed herein, wherein the filter insert part comprises the at least one guide rib, which is covered at least partially by filter medium and is present adjacent to the opening, wherein the filter insert part can be coupled detachably to a housing side wall of the brake dust particle filter.

The dependent claims provide preferred further embodiments.

The brake dust particle filter according to the invention is intended for a disc brake assembly with a brake disc and a brake caliper and is configured to catch particles produced during braking. The brake dust particle filter comprises a ring segment-shaped housing for at least partial accommodation of the brake disc in a housing interior, wherein the housing comprises two housing side walls which are axially spaced apart from each other and a housing circumferential wall section which extends radially outwardly in circumferential direction. The housing circumferential wall section is arranged or embodied between the housing side walls. Furthermore, the brake dust particle filter comprises at least one guide rib projecting in the housing interior inwardly from at least one housing side wall at least in sections with at least one axial component. The guide rib is arranged adjacent to at least one opening present in the housing side wall and is at least partially covered by a filter medium.

The opening connects in this context the housing interior in fluid communication to an exterior space which is not enclosed by the housing so that an air flow between the housing interior and the exterior space, or vice versa, is enabled through the opening.

Housing side wall is to be understood as a wall of the housing which in a mounted arrangement of the brake dust particle filter extends normally to a rotation axis of the brake disc or parallel to a friction surface of the brake disc.

Due to the combination according to the invention of a guide rib projecting with at least one axial component from the housing side wall into the interior as well as the opening of the housing side wall adjacent thereto, the housing inner pressure is advantageously lowered in operation of the brake dust particle filter. The guide rib present within the housing interior effects together with the corresponding opening the function of “venting gills”. A circumferential flow which is entrained with the rotation of the brake disc due to the boundary layer effects can escape in the brake dust particle filter according to the invention through the opening in the housing side wall, wherein the particle-laden flowing air is guided past the filter medium or is guided through the filter medium. Due to the significantly reduced housing interior pressure in operation, the total separation degree of the system increases because fewer gap losses occur. Furthermore, the brake dust particle filter according to the invention also makes it possible to regulate the effects on the housing interior pressure resulting from an inner ventilation of the brake disc.

Due to the through-flow possibility of housing interior and exterior space in operation provided by the opening, a particle-laden air flow extending from the housing interior to the exterior space can at least pass across the filter medium, which is arranged on the guide rib, wherein the particles are separated by the filter medium or adhere to the filter medium. The invention combines thus the aspect of inner pressure reduction with a particle separation function which, in the meaning of a combinatorial effect, both contribute to an improved separation performance of the brake dust particle filter.

Particularly advantageously, the guide ribs relative to a plane of the housing side wall can be positioned at a slant so that the circumferential flow, which has been described above herein, can be optimally “caught” and deflected through the opening.

The intended effect according to the invention is based on a functional combination of the opening in the side wall with the guide rib which is arranged adjacent thereto and at least partially covered by filter medium. The device components alone explicitly do not lead to the desired effect.

The opening can have in particular a rectangular or parallelogram-shaped configuration.

The ring segment-shaped housing covers preferably a large angle range of the brake disc in order to achieve a high filtration effect. The housing extends in this context preferably across a ring segment angle of more than 35°, in particular of more than 55°, particularly preferred of more than 75°. When selecting a suitable engagement angle, a conflict of objectives between the share of particles to be filtered and the cooling effect which can be provided to the disc brake must be solved.

For facilitating mounting of the housing, the housing can comprise a first and a second housing part. The two housing parts in this context can be preferably at least partially axially arranged at both sides of the brake disc. Particularly preferred, the first housing part and the second housing part are reversibly detachably connectable to each other. Alternatively, the two housing parts can also be non-detachably connected, for example, welded. In one of the housing parts, preferably in the housing part which in the mounted arrangement is axially inwardly positioned, a holding device can be integrated by means of which the brake dust particle filter can be connected relatively stationarily in relation to a wheel carrier of a motor vehicle.

For connecting the two housing parts, a screw connection, a clip connection, a folding mechanism and/or a pivot mechanism can be provided.

In an embodiment of the invention, one of the housing parts of the brake dust particle filter can be a splash guard element, in particular a splash guard plate, which, inwardly positioned, covers the brake disc at least partially. In this way, an additional splash guard plate can be dispensed with so that weight can be saved which, due to an arrangement in the unsprung region of a carriage, provides advantages regarding driving dynamics.

The filter medium can be fastened indirectly or directly at the guide rib, e.g., with form fit or material fusion, e.g., welded.

The filter medium is preferably configured such that, even at a temperature of more than 600° C., it is stable in order to be able to withstand the temperatures in the immediate environment of a disc brake. The filter medium can comprise in this context a metal, a metal fiber nonwoven, glass, ceramic and/or a high temperature-resistant synthetic material, in particular polyetheretherketone. However, the housing should also have advantageously a sufficient temperature resistance; for this purpose, it can be embodied of sheet metal, preferably sheet steel. In addition to the excellent temperature resistance, sheet steel has the additional advantage that the housing can be obtained by a simple forming process, for example, by deep drawing.

In embodiments, the at least one guide rib can be embodied as one piece together with the housing side wall. Alternatively, it can be detachably or non-detachably connected to the housing side wall or can be present at a separate component which, in turn, is connected to the housing side wall, for example, a filter insert part.

According to a further embodiment, the filter medium can fill a gap between an end of the guide rib proximal to the housing side wall and an oppositely positioned edge of the opening by at least 50%, preferably by at least 75%. One could refer to this alternatively as a “degree of coverage” (% of the opening cross section of the opening). By a targeted selection of the gap width as well as of the filtration-relevant parameters of the filter medium, in particular its air permeability (l/m2s), the desired inner pressure-reducing effect can be adapted to the individual application situation. In embodiments, it can also be explicitly provided that the filter medium fills 100% of the gap between an end of the guide rib proximal to the housing side wall and an oppositely positioned edge of the opening, i.e., the opening is completely closed by the filter medium.

In a preferred embodiment, the guide rib is at least present at the housing side wall which, in a mounted arrangement, faces the vehicle exterior side; in this way, the air flow can be guided optimally from the housing interior into the environment. In other embodiments, at the housing side wall which, in the mounted arrangement, faces the vehicle inner side, at least one rib as well as at least one corresponding opening can be present; this is referred to as symmetric configuration. The symmetric configuration has the advantage that the housing inner pressure can be lowered even more effectively and that more filter surface can be made available. However, due to installation space restrictions, this is not possible in every application.

According to a likewise preferred embodiment, distributed about a circumference of the side wall, a plurality of guide ribs can be provided which each are arranged adjacent to a corresponding opening, wherein the guide ribs at least partially are covered by filter medium. This has the advantage that the housing inner pressure can be lowered even more effectively and that more filter surface can be made available. In this context, the openings can be present parallel displaced relative to each other, i.e., at least one boundary edge of the openings are parallels. Alternatively, the arrangement can also be such that the boundary edges of the openings extend radially, respectively, and the circumferential arrangement is provided in this way. In embodiments, at least one guide rib, preferably all guide ribs, can be covered completely areally by filter medium. Advantageously, an ideal utilization of the available surfaces of the guide ribs for filtration purposes results in this way. Preferably, the guide rib can be positioned relative to the side wall at an acute angle, preferably an angle in a range of 10° to 75°, particularly preferred an angle in a range of 25° to 60°. By a suitable selection of the “incident angle”, a targeted adaptation of the flow-guiding effect of the guide rib(s) to the flow conditions in the individual application situation can be achieved. This means, in this way, the conflict of objectives between housing inner pressure reduction and desired filtration performance can be influenced. In an especially particularly preferred embodiment, the guide rib is set at an incident angle opposite to a predetermined forward travel rotation direction of the brake disc in a mounted state. When set at an incident angle opposite to the rotational direction, herein above-described circumferential flow can be deflected optimally and thereby the housing inner pressure particularly effectively lowered. In embodiments, the guide rib extends as close as possible (i.e., as close as necessary while maintaining tolerance and safety requirements) axially to a friction surface of the brake disc in the mounted state. This is associated with the advantageous effect that the brake dust particles which are contained with particularly high concentration in the boundary layer flow are supplied to the filtration by deflection of the flow by means of the guide ribs. Alternatively or additionally, a length extension of the guide rib can run in radial direction or tangential direction. Moreover, it can be provided that at least two of the guide ribs are positioned at a differently sized acute angle relative to the housing side wall and/or extend differently far axially away from the housing side wall into the housing interior. With these measures, an important influencing possibility is provided in order to influence the pressure conditions in the housing interior not only globally but locally. In this way, by a suitable selection of the angle and/or the length of the respective guide ribs, an equal pressure distribution can be achieved, for example, across the entire housing circumference and, in this way, disadvantageous local excess pressure can be counteracted.

The guide rib can have a flat cross section shape and can comprise at least one base surface which is facing the housing side wall, a cover surface projecting into the housing interior as well as at least one side face, wherein at least the at least one side face is covered at least partially by the filter medium. In embodiments, also both side faces of the guide rib can be covered by filter medium. The base surface must not be a “free surface”, but it can be expressly present at the housing side wall, wherein in particular across the base surface a connection of the guide rib with the housing side wall can be produced. In embodiments, the base surface is therefore a virtual cross section surface.

In a preferred embodiment, the guide rib can have a substantially rectangular cross section, wherein a ratio of a wide side to a narrow side of the rectangular cross section lies between 15 and 60, preferably between 20 and 40. Such values can be realized for a plurality of construction sizes of the brake dust particle filter by use of sheet metal in standard thicknesses for manufacturing the at least one guide rib; for example, sheet metal with a thickness (=narrow side of the cross section) between 0.5 and 4 mm can be used.

The guide rib is preferably configured to be fluid-impermeable, or the guide rib comprises at least one through passage that is covered by the filter medium.

However, it is not mandatory in this context that the guide rib forms a continuous body without interruptions; instead, it can also be slotted once or multiple times. For such slotted guide ribs, the aforementioned ratio specifications relate to an outer contour of the respective guide rib and not to the “partial ribs” that are formed by slots.

In a further preferred embodiment, from the other housing side wall at least one additional guide rib covered at least partially by filter medium can project into the housing interior with at least one axial component, wherein the additional guide rib is arranged adjacent to at least one additional opening present in the other housing side wall. This embodiment characterizes in more detail the above-mentioned symmetric configuration herein.

In an especially particularly preferred embodiment, the at least one guide rib covered at least partially by filter medium as well as the corresponding opening can be present in a filter insert part which is detachably coupled to the housing side wall. This has the advantage that servicing of the brake dust particle filter (exchange of the filter medium, cleaning as needed) is very simple and comfortable because for this purpose only the filter insert part must be separated from the housing, and it is not required to separate the entire housing from the vehicle. The filter insert part in embodiments can comprise in particular a side wall section with which it is inserted into a corresponding opening of the housing side wall. The side wall section of the filter insert part forms in the mounted state a portion of the housing side wall and comprises the opening as well as the guide rib arranged thereat.

Furthermore, the housing can comprise at a circumferential end region a brake caliper connection region which corresponds with a contour of a predetermined brake caliper. The brake caliper connection region is adapted to a geometry of a brake caliper in a concrete application and is configured primarily for keeping the gap losses at this location as small as possible in that gap widths are reduced as much as possible. In embodiments, the brake dust particle filter is mounted in a mounted arrangement such that it is arranged downstream of the brake caliper in circumferential direction in the direction of a predetermined forward travel rotation direction of the brake disc.

Moreover, the housing can comprise at a circumferential end facing away from the brake caliper connection region an end wall which connects at least one of the housing side walls to the circumferential wall section and which extends preferably parallel to a rotation axis of the brake disc in the mounted state. The end wall essentially closes off the housing of the brake dust particle filter in the mounted arrangement at an end which is remote from the brake caliper. For this purpose, a receiving slot for the brake disc can be provided in the end wall so that the end wall comprises a substantially U-shaped configuration. The width of the receiving slot can be dimensioned in relation to a brake disc thickness such that a gap between a friction surface of the brake disc and an oppositely positioned edge of the end wall is as small as possible in the mounted state.

Preferably, the lengths of the guide ribs can increase in circumferential direction away from the brake caliper connection region and/or an opening cross section of the openings can increase in circumferential direction away from the brake caliper connection region. As has already been discussed above herein, in this way an influencing possibility is provided in order to not only globally but also locally influence the pressure conditions in the housing interior.

By a suitable configuration of the length of the respective guide ribs and/or of the opening cross sections of the corresponding openings, an equal pressure distribution can be achieved in this way, for example, across the entire housing circumference, and disadvantageous local excess pressure can be counteracted in this way.

Since it has been recognized that in particular housing sections of the brake dust particle filter which are proximal to the brake caliper connection region are affected by disadvantageous local excess pressure, a particularly effective measure for equalization of the pressure conditions is disclosed thereby.

The housing can be embodied preferably as a sheet metal construction and the guide rib as well as the corresponding opening realized preferably as formed parts. In this context, for example, the opening can be stamped first along three of its edges from the sheet metal part, wherein the guide rib is obtained by folding the partially stamped region inwardly. This is particularly inexpensive because only a few method steps are incurred and complex joining processes can be dispensed with.

A further aspect of the invention concerns a disc brake assembly with a brake disc, a brake caliper, and a brake dust particle filter according to the invention. The features and feature combinations disclosed in relation to the brake dust particle filter according to the invention as well as their advantageous technical effects can be applied to the disc brake assembly according to the invention, and vice versa.

The brake dust particle filter can comprise a stationary position relative to the brake caliper, to a wheel bearing housing and/or to a splash guard. Alternatively or additionally, the brake dust particle filter can be fastened to the brake caliper, to a wheel bearing housing and/or to a splash guard, wherein an attachment at the brake caliper can be advantageously provided when a so-called fixed caliper is concerned. Particularly advantageously, the brake dust particle filter can be connected at the same fastening points to the wheel bearing housing as the brake caliper. Furthermore, the screws with which the brake caliper is screwed to the wheel bearing housing can comprise, at least in the region of a screw head, a blind bore thread so that the brake dust particle filter can be connected to the screws so that advantageously the safety-critical screw connection of the brake caliper (holder) to the wheel bearing housing is not influenced (settling/pretension force change).

In particular, the brake dust particle filter is arranged such that the latter adjoins flush the brake caliper in circumferential direction of the housing, in particular is arranged downstream in rotational direction of the brake disc for intended forward travel.

In order to effect a particularly effective particle separation, the brake dust particle filter is arranged so as to adjoin preferably immediately the brake caliper.

Finally, a further aspect of the invention concerns a filter insert part of a brake dust particle filter according to the invention, wherein the filter insert part comprises the at least one guide rib, which is covered at least partially by filter medium and is present adjacent to at least one opening, and can be coupled detachably to a housing side wall of the brake dust particle filter.

The features and feature combinations disclosed in relation to the brake dust particle filter according to the invention as well as to the disc brake assembly according to the invention as well as their advantageous technical effects can be applied to the filter insert part according to the invention, and vice versa.

Further features and advantages of the invention result from the following description of a plurality of embodiments of the invention, from the claims as well as the Figures illustrating details important to the invention. The features disclosed in the Figures are illustrated such that the particularities of the invention can be made clearly visible. The various features can be realized individually by themselves or several thereof combined in any combinations in variants of the invention and are accordingly combinable with each other.

### BRIEF DESCRIPTION OF THE DRAWINGS

FIG. 1 shows a plan view of the disc brake assembly according to the invention according to a first embodiment.

FIG. 2 shows a section A-A according to FIG. 1.

FIG. 3 shows an isometric view of the brake dust particle filter according to the invention with removed filter medium according to a first embodiment.

FIG. 4 shows an isometric view of the brake dust particle filter according to the invention with removed filter medium according to a second embodiment.

FIG. 5 shows a plan view of the disc brake assembly according to the invention according to a second embodiment.

FIG. 6 shows a section B-B according to FIG. 5.

FIG. 7 shows an isometric view of the brake dust particle filter according to the invention with filter medium according to a third embodiment.

FIG. 8 shows an isometric view of a filter insert part according to the invention.

### DETAILED DESCRIPTION

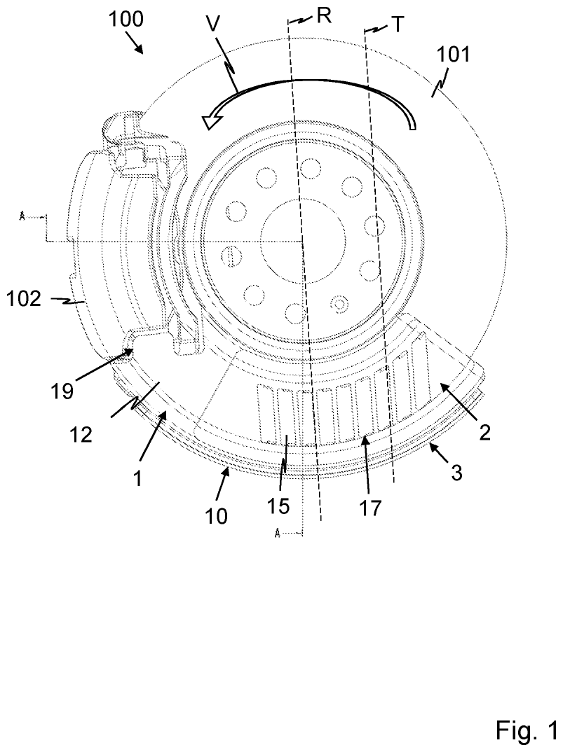

FIG. 1 shows a plan view of a disc brake assembly 100 according to the invention which comprises a brake disc 101, a brake caliper 102 as well as a brake dust particle filter 10. The brake dust particle filter 10 is arranged downstream of the brake caliper 102 in a predetermined forward travel rotation direction V so that it can take up brake dust particles which are produced by friction contact between the brake pads (not illustrated) of the brake caliper 102 and the brake disc 101. The brake dust particle filter 10 comprises a housing 1 which is embodied in a ring segment shape, namely circular ring segment shape, and which surrounds the brake disc 101 across a defined angle range and in this way houses it on both sides as well as radially outwardly. At its circumferential end region, which is proximal to the brake caliper 102, the housing 1 comprises a brake caliper connection region 19 which is matched to a contour of the brake caliper 102 at the interface in order to keep gap widths here as small as possible and in this way minimize gap losses. The housing 1 has two axially spaced apart housing side walls 12, 13 between which the brake disc 101 is accommodated and comprises a housing circumferential wall section 14 which extends radially outwardly in circumferential direction and is arranged or embodied between the housing side walls 12, 13. One can therefore say that the housing circumferential wall section 14 delimits the housing at least partially in radial direction.

In relation to the brake caliper 102, the housing 1 is relatively stationarily arranged, in particular it can be fastened to a wheel carrier, a suspension strut, a splash guard plate or similar device components of a vehicle.

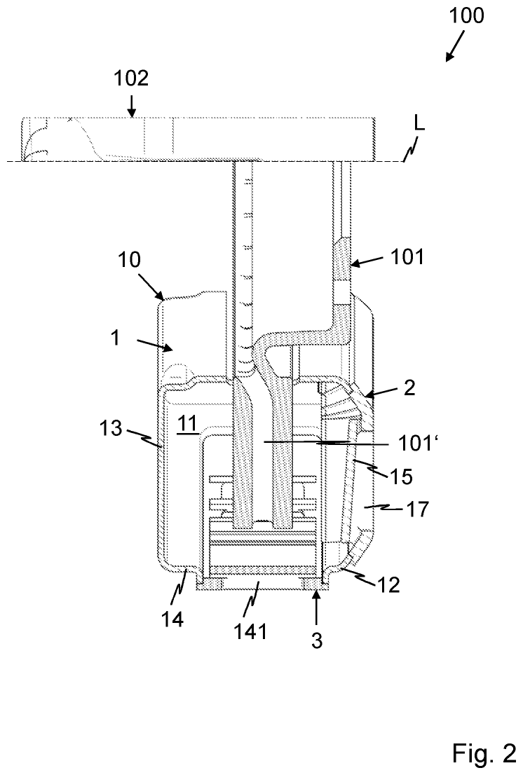

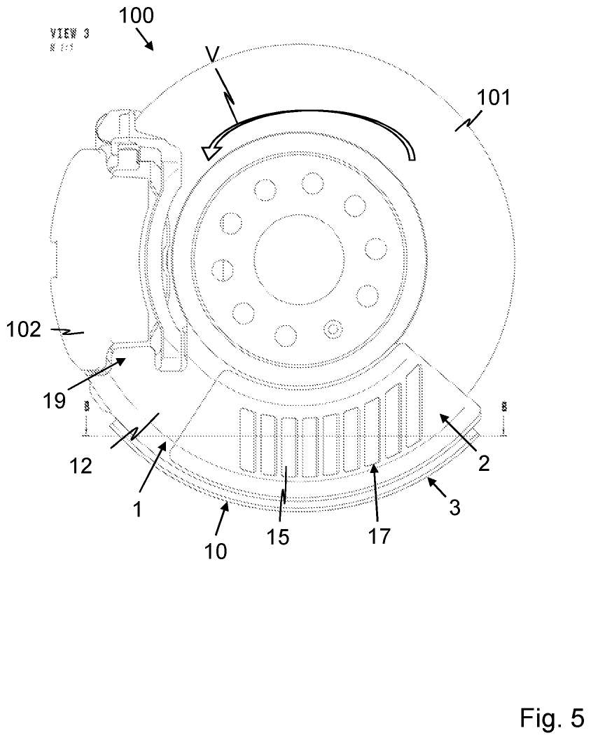

In the housing side wall 12, a plurality of openings 17 are provided which in circumferential direction are spaced apart from each other and which connect the environment to an interior 11 enclosed by the housing 1 (see inter alia FIG. 2). The openings 17 are embodied rectangular or parallelogram-shaped and are oriented parallel to each other, respectively. In other embodiments, not illustrated, they can however also have any other shape which appears suitable to a person of skill in the art; the invention is not limited to a certain shape of the openings 17. Adjacent to the openings 17, guide ribs 15 extend away from the housing side wall 12 into the interior 11 of the housing, respectively, wherein the guide ribs according to the invention are covered by a filter medium 16 (see inter alia FIG. 5 ff). For better illustration of the embodiment of the guide ribs, the filter medium 16 is removed in FIGS. 1 through 4.

The openings 17 as well as a length extension of the guide ribs 15 arranged thereat extend in radial direction R or tangential direction T (depending on which rib is being considered).

In operation of the brake dust particle filter 10 in its mounted state in a disc brake assembly 100, a pressure compensation between the interior 11 and the environment is provided by means of the openings and guide ribs. Without measures for pressure compensation, a relative excess pressure which leads to great gap losses (e.g., at the interface to the brake caliper as well as in relation to the brake disc) would be generated in the housing 1 due to a circumferential flow which is entrained as a result of boundary layer effects by the rotation of the brake disc. The brake dust particle filter according to the invention however not only provides a pressure compensation of the housing but also utilizes, due to the at least partial coverage of the guide ribs 15 with filter medium, the venting action at the same time for particle separation. The filter medium in embodiments can completely cover an opening cross section of the openings 17, respectively, so that purely a flow through the filter medium takes place, or, alternatively, can cover an opening cross section of the openings 17 to at least 50% so that a mixed form of flow across and flow through the filter medium takes place. By a suitable selection of the thickness of the filter medium, a corresponding adaptation can be realized, wherein thereby also a volume flow distribution of the openings 17 among each other can be realized. The guide ribs 15 can be in particular formed as one piece together with the housing side wall 12 and can be produced, for example, by a forming process (stamping the openings 17 and bending the guide ribs 15 inwardly). In embodiments, they can however also be joined to the housing side wall 12, for example, welded.

According to the illustrated embodiment, the openings 17 as well as the guide ribs 15 arranged thereat are provided on a filter insert part 2 which is detachably inserted into the housing side wall 12 and which in a servicing situation (loaded filter medium) enables a simple exchange of the filter medium without the complete filter housing 1 having to be separated from the vehicle.

The here illustrated brake dust particle filter 10 has furthermore a circumferential filter insert part 3 in which further filter medium is present. The present invention is however explicitly not limited to a combination with a circumferential filter insert part 3 but encompasses arbitrary brake dust particle filters 10 independent of the configuration of its housing circumferential wall section 14 which can also be configured to be completely closed. However, in preferred embodiments, the housing circumferential wall section 14 is also embodied at least in sections to be air-permeable and comprises a filter medium which covers at least one opening of the housing circumferential wall section 14.

In the side view of the section A-A of FIG. 1, which is illustrated in FIG. 2, the interior of the brake dust particle filter 10 is illustrated in detail. The brake disc 101 is here a brake disc 101 with inner ventilation comprising inner ventilation channels 101′ through which an air flow can be conveyed radially outwardly. The invention encompasses, of course, also embodiments with solid brake discs. In an embodiment with a brake disc 101 with inner ventilation, it is particularly advantageous when, as already explained above, in the circumferential wall section 14 at least one outflow opening 141 is provided because in this way the ventilation volume flow can exit the housing 1, and in this way a relative excess pressure in the interior 11 can be lowered even more effectively. Suitably, the outflow opening 141 is covered by a filter medium.

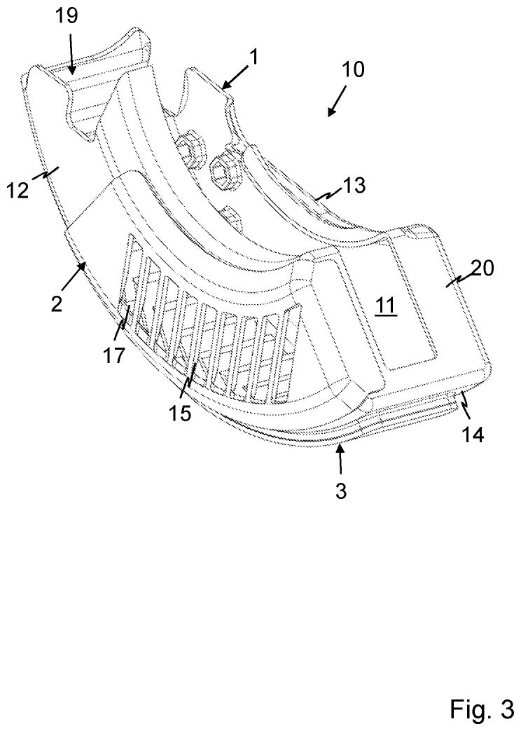

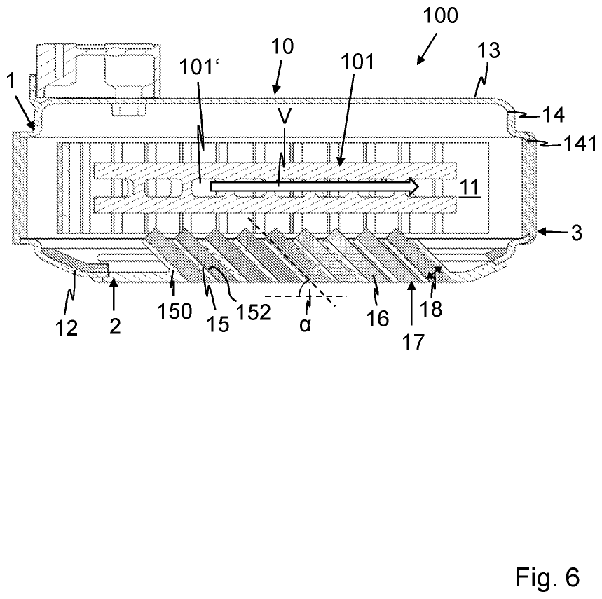

According to the embodiment of the brake dust particle filter 10 illustrated in FIG. 3, the latter comprises exclusively in one side wall 12 openings 17 with guide ribs 15 arranged thereat. The guide ribs 15 are slanted in relation to the housing side wall 12, respectively, so that they are set at an incident angle opposite to the forward travel rotation direction V; see FIG. 6. Due to this incident angle setting of the guide ribs 15, the circumferential volume flow conveyed with the brake disc 101 can be particularly effectively “caught” and supplied for venting through the openings 17. In embodiments, the guide ribs 15 extend as close as possible (i.e., as close as necessary while maintaining tolerance and safety requirements) axially to a friction surface of the brake disc in the mounted state. This entails the advantageous effect that the brake dust particles contained at particularly high concentration in the boundary layer flow can be supplied to the filtration by deflection of the flow by means of the guide ribs.

The housing 1 comprises at a circumferential end which is facing away from the brake caliper connection region 19 an end wall 20 which connects the housing side walls 12, 13 to the housing circumferential wall section 14 and which extends parallel to the rotation axis L of the brake disc 101. The end wall 20 closes off the housing 1 at an end which is remote from the brake caliper.

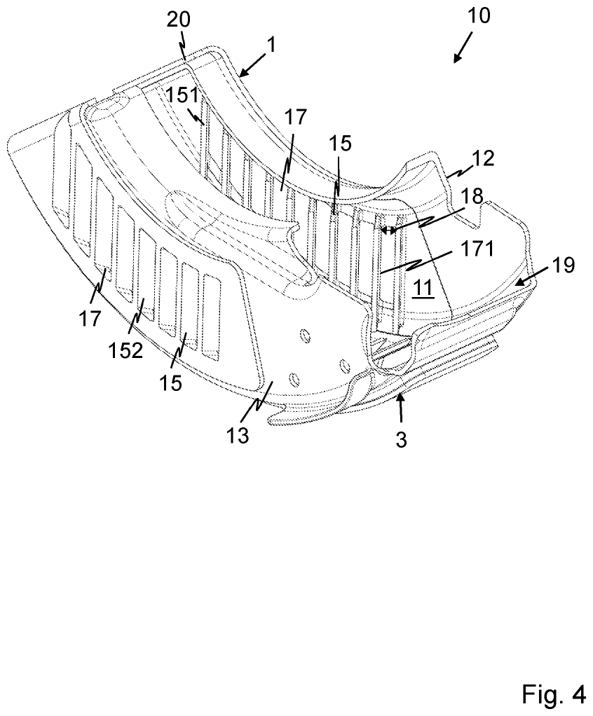

In FIG. 4, a further embodiment of the brake dust particle filter 10 is now illustrated which comprises in both housing side walls 12, 13 openings 17 with guide ribs 15 arranged thereat. This is also referred to as a symmetric configuration and permits an even more effective inner pressure reduction as well as improved filtration due to the larger available surface.

At least one side face 152 of the guide ribs 15 is covered at least partially by filter medium. A cover surface 151 (end face at the free end) can however also be covered by filter medium. The guide ribs 15 can also be covered at both sides (side faces 152 facing away from each other) by filter medium.

At an end of the guide ribs 15 which is proximal to one of the housing side walls 12, 13, a respective gap 18 between the guide rib 15 and an oppositely positioned edge 171 of the opening 17 is present, present in a predetermined width, which corresponds to an opening width of the opening cross section.

The disc brake assembly 100 illustrated in FIG. 5 corresponds substantially to the disc brake assembly 100 according to FIG. 1. The determining factor is here the position of the section B-B which determines the top view of FIG. 6 in which the brake dust particle filter according to the invention is now illustrated for the first time with filter medium 16.

Here, the incident angle position of the guide ribs 15 at an angle α relative to the forward travel rotation direction V can be seen well and it can be seen that the guide ribs 15 closely approach a friction surface of the brake disc 101. In embodiments (not figuratively illustrated), in particular an incident angle of the guide ribs 15 in circumferential direction can vary in order to achieve a homogenous pressure distribution in the interior 11. Other measures for this purpose are a variable opening cross section of the openings 17 in circumferential direction and/or a variable thickness of the filter medium 16 in circumferential direction.

The guide ribs 15 are covered on their side faces 152 by filter medium. With their base surface 150 facing away from the cover surface 151, they are present at the housing side wall 12. For a one-part embodiment of guide ribs 15 and side wall 12, the base surface 150 is therefore not an outer surface but a virtual plane. The filter medium 16 in the illustrated embodiment is almost as thick as the width of the gap 18 between the guide rib 15 at its end proximal to the side wall 12 and an oppositely positioned edge of the opening 17; here, the coverage amounts to approximately 90%. However, a minimal cross section which can be flowed through freely between a surface of the filter medium and the oppositely positioned edge of the opening 17 remains in which the filter medium 16 is flowed across.

The filter medium 16 is present in particular as a flat material and is attached to the guide ribs 15, for example, welded to the side face 152.

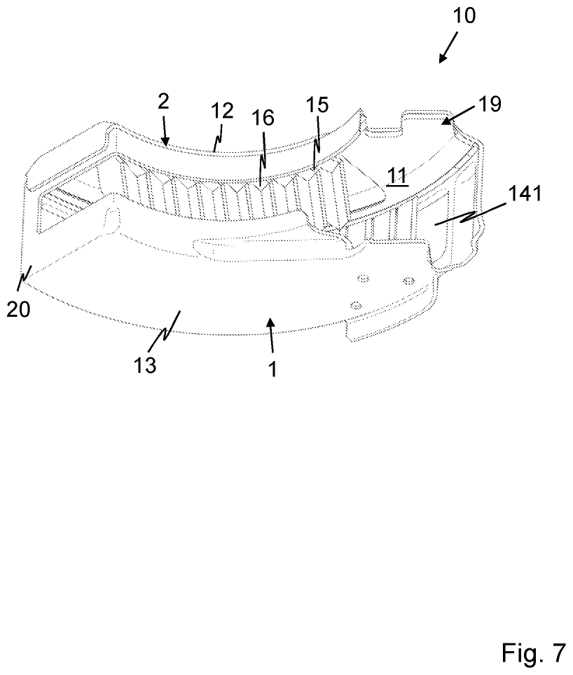

FIG. 7 shows a third embodiment of the brake dust particle filter 10 which is very similar to the embodiment of FIG. 3 (openings and guide ribs on one side) and in which the filter medium 16 is illustrated. According to this embodiment, the openings as well as the guide ribs 15 arranged thereat are also present in a filter insert part 2 which is inserted detachably into the housing side wall 12.

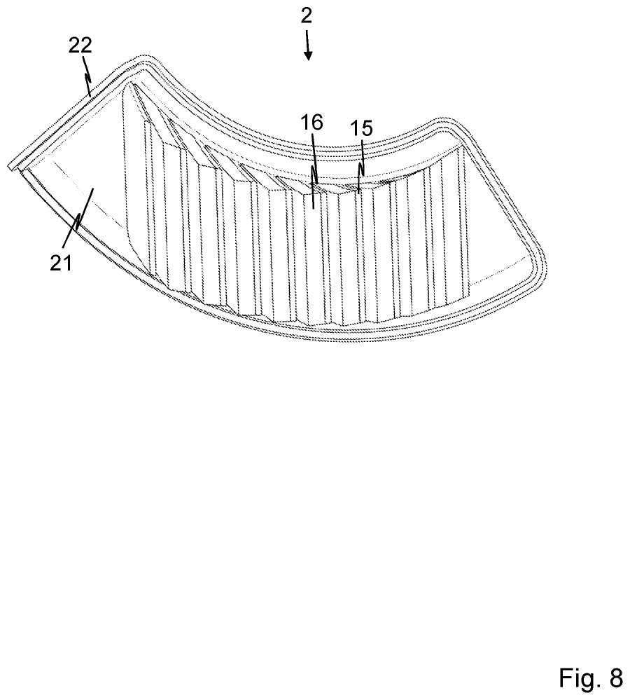

The filter insert part 2 comprises circumferentially at the end an end wall section 22 (see FIG. 8) which engages across the end wall 20 of the housing 1 at least partially and enables in this way a circumferential positioning of the filter insert part 2.

The filter insert part 2 itself is illustrated in FIG. 8. It can be inserted detachably into a mounting recess provided in the housing side wall of the brake dust particle filter and is provided with a side wall section 21 in which a plurality of openings are provided, with a guide rib 15 extending away therefrom, respectively, and at least partially covered by filter medium 16. The guide ribs 15 extend in the same direction away from the side wall section 21 as the end wall section 22 so that, in the installed state (filter insert part inserted into the housing of the brake dust filter), they extend into an interior of the housing of the brake dust filter. The side wall section 21 of the filter insert part 2 comprises a circular ring segment shape which corresponds to the ring segment-shaped form of the housing of the brake dust particle filter.

1. A brake dust particle filter for a disc brake assembly comprising a brake disc and a brake caliper, the brake dust particle filter being configured to catch particles produced during braking, and the brake dust particle filter comprising:
a ring segment-shaped housing configured to at least partially accommodate the brake disc, and comprising:
a housing interior;
a first housing side wall and a second housing side wall that are axially spaced apart from each other, the first housing side wall comprising a respective first opening; and
a housing circumferential wall section extending radially outwardly in a circumferential direction of the ring segment-shaped housing, the housing circumferential wall section being interposed between the first housing side wall and the second housing side wall; and
one or more first guide ribs projecting inwardly, at least in sections with at least one axial component, into the housing interior away from the first housing side wall, the one or more first guide ribs being disposed adjacent to the respective first opening included in the first housing side wall, and the one or more first guide ribs being covered at least partially by a first filter medium,
wherein the respective first opening connects the housing interior in fluid communication to an exterior space not enclosed by the ring segment-shaped housing so that, through the respective first opening, an air flow is enabled between the housing interior and the exterior space, or vice versa.

2. The brake dust particle filter according to claim 1, wherein the one or more first guide ribs are disposed immediately at the respective first opening.

3. (canceled)

4. The brake dust particle filter according to claim 1, wherein the first housing side wall faces a vehicle exterior side in a mounted arrangement of the brake dust particle filter.

5. The brake dust particle filter according to claim 1, wherein the one or more first guide ribs and the respective first opening are distributed about a circumference of the first housing side wall.

6. The brake dust particle filter according to claim 1, wherein the one or more first guide ribs are covered completely areally by the first filter medium.

7. The brake dust particle filter according to claim 1, wherein the one or more first guide ribs are positioned at an acute angle relative to the first housing side wall.

8. (canceled)

9. (canceled)

10. (canceled)

11. The brake dust particle filter according to claim 1, wherein a length extension of the one or more first guide ribs runs in a radial direction or in a tangential direction.

12. The brake dust particle filter according to claim 1, wherein at least two of the one or more first guide ribs extend axially differently away from the first housing side wall into the housing interior.

13. The brake dust particle filter according to claim 1, wherein each of the one or more first guide ribs comprises a flat cross section shape and a base surface facing the first housing side wall, a cover surface projecting into the housing interior, and at least one side face being covered at least partially by the first filter medium.

14. (canceled)

15. The brake dust particle filter according to claim 1, further comprising one or more second guide ribs being covered at least partially by a second filter medium and projecting from the second housing side wall with at least one axial component into the housing interior, each of the one or more second guide ribs being disposed adjacent to a respective second opening included in the second housing side wall.

16. The brake dust particle filter according to claim 15, wherein the one or more second guide ribs are configured to be fluid-impermeable, or comprise at least one through passage covered by the second filter medium.

17. The brake dust particle filter according to claim 15, further comprising a filter insert part coupled detachably to the second housing side wall,
wherein the one or more second guide ribs and the respective second opening are disposed in the filter insert part.

18. The brake dust particle filter according to claim 15, wherein, viewed in the circumferential direction in a direction away from a brake caliper connection region of the brake dust particle filter, lengths of the one or more second guide ribs increase and/or opening cross sections of respective second opening increase.

19. The brake dust particle filter according to claim 15, wherein the ring segment-shaped housing is a sheet metal construction, and
the one or more first guide ribs, the respective first opening, the one or more second guide ribs and the respective second opening are formed parts of the sheet metal construction.

20. The brake dust particle filter according to claim 1, wherein the one or more first guide ribs are configured to be fluid-impermeable, or comprise at least one through passage covered by the first filter medium.

21. The brake dust particle filter according to claim 1, further comprising a filter insert part coupled detachably to the first housing side wall,
wherein the one or more first guide ribs and the respective first opening are arranged in the filter insert part.

22. The brake dust particle filter according to claim 1, wherein, viewed in the circumferential direction in a direction away from a brake caliper connection region of the brake dust particle filter, lengths of the first guide ribs increase and/or opening cross sections of respective first openings increase.

23. The brake dust particle filter according to claim 1, wherein the ring segment-shaped housing is a sheet metal construction, and
the one or more first guide ribs and the respective first opening are formed parts of the sheet metal construction.

24. (canceled)

25. (canceled)

26. A disc brake assembly comprising:
a brake disc;
a brake caliper disposed at the brake disc; and
the brake dust particle filter according to claim 1 and disposed at the brake disc.

27. (canceled)

28. A filter insert part of the brake dust particle filter according to claim 1, the filter insert part comprising:
the one or more first guide ribs covered at least partially by the first filter medium; and
the respective first opening,
wherein the filter insert part is configured to be coupled detachably to the first housing side wall of the brake dust particle filter.
